(19) United States
(12) Patent Application Publication
(10) Pub. No.: US 2011/0087505 A1
(43) Pub. Date: Apr. 14, 2011

(54) METHOD AND SYSTEM FOR DAMAGE REPORTING AND REPAIR

(75) Inventor: Frank M. TERLEP, Poway, CA (US)

(73) Assignee: SUMMIT MOBILE SOLUTIONS, INC., Poway, CA (US)

(21) Appl. No.: 12/904,648

(22) Filed: Oct. 14, 2010

Related U.S. Application Data
(60) Provisional application No. 61/251,476, filed on Oct. 14, 2009.

(51) Int. Cl. G06Q 40/00; G06F 17/30

(52) U.S. Cl. 705/4; 707/812; 707/E17.005

(57) ABSTRACT

The present invention provides a system and method for the reporting and repair of damage to a vehicle. The system and method may provide a convenient and direct connection between consumers and repair entities. Such a connection allows repair entities and consumers to circumvent insurance steering practices. In some exemplary embodiments a user is able to develop and maintain a preferred group of repair entities. In some embodiments, an electronic device may search for, and allow a user to connect directly to, service companies like rental agencies. Some exemplary embodiments described herein also facilitate the collection and reporting of information related to an accident. In some embodiments, emergency services or other services, such as rental companies, may be located and informed of the accident. Information may be collected and stored for use by repair entities or insurance companies.

### RELATED APPLICATIONS

This application claims priority to U.S. Provisional application Ser. No. 61/251,476, filed on Oct. 14, 2009. The contents of the aforementioned application are incorporated herein by reference.

### Background

Vehicle insurance relates to insurance for cars, trucks, and other vehicles. The purpose of vehicle insurance is to protect a vehicle owner or operator from losses due to, among other things, vehicle theft or accidents. A vehicle owner or operator typically purchases an insurance policy that covers the operation of one or more vehicles by one or more operators. When the owner of an insurance policy wishes to exercise the policy in order to be reimbursed for damage to the vehicle, the owner of the insurance policy typically files a claim with the insurance company that issued the policy. The owner of the insurance policy has the vehicle repaired by a suitable vehicle repair entity, and the insurance company pays for some or all of the repairs, either by paying the cost of the repair directly to the vehicle repair entity or by reimbursing the owner of the insurance policy for the cost of the repair. In many jurisdictions, a vehicle operator is required to have vehicle insurance as a prerequisite to operating a vehicle.

Insurance steering is a process employed by insurance companies to encourage repair entities to repair (rather than replace) damaged parts, to replace damaged parts with used (rather than new) parts, and to obtain the lowest possible hourly labor rate. As a result, vehicle repairs were performed as cheaply as possible, but not necessarily at as high a quality as possible.

Insurance steering may involve an insurance provider informing a policy holder that the policy holder is required to have their vehicle repaired at a provider-approved repair entity, or may be more subtle. For example, insurance agents may explicitly ask a vehicle owner to take their vehicle out of a local repair shop and bring it to a favored repair entity. The insurance companies may try to persuade the vehicle owner to take their vehicle to the favored repair entity through the use of incentives, like faster turnaround, the offer of a rental car through a an on-site rental company, or a guarantee on the work by the insurance company. The insurance agents may suggest that choosing to have the work done at the local repair shop will be more difficult for the vehicle owner than having the same work done at a favored repair entity, for example by suggesting that there will be a lengthy time delay for the insurance company to review the damage to the vehicle before repairs can be made at the local repair shop.

Further, if the local repair shop and the insurance company cannot come to an agreed price, the insurance company may refuse outright to pay for the repairs. Employees of the insurance agencies may be evaluated based on how many vehicles the employee is able to keep in the insurance company's network of preferred repair entities, and employees that steer the most vehicles to favored repair entities may be rewarded. Insurance companies may provide forms to vehicle owners that omit language designed to protect consumers, even when the language is required by law.

Accordingly, some repair entities which are not on the “favored” list of insurance companies are overlooked when a potential customer determines that a repair is to be made to their vehicle. Further, vehicle owners may receive a lower quality of work at a “favored” shop due to pressure to keep costs as low as possible, thereby maintaining the shop on the insurer's favored list.

Although insurance steering is illegal in many jurisdictions, steering practices remain a problem. Some insurance companies continue to make recommendations of preferred vehicle repair entities without informing customers that they have a right to choose where the repairs are made. As a result, some customers believe that they are required to have the repairs made at the preferred repair shop.

### SUMMARY

The present application is related to a system and method for the reporting and repair of damage to a vehicle. The system and method may provide a convenient and direct connection between consumers and repair entities. Such a connection informs a consumer of their options, allows the consumer to select a repair entity that will provide a high-quality repair at a reasonable cost, increases competition between repair entities, and allows repair entities and consumers to circumvent insurance steering practices. Further, in some exemplary embodiments a user is able to develop and maintain their own preferred group of repair entities, which may help to develop and maintain relationships between customers and high quality repair entities as well as encourage repeat business for high quality repair entities. Still further, some embodiments of the present invention may search for, and allow a user to connect directly to, service companies like rental agencies.

Some exemplary embodiments described herein also facilitate the collection and reporting of information related to an accident. In some embodiments, emergency services or other services, such as rental companies, may be located and informed of the accident. Information may be collected and stored for use by repair entities or insurance companies. Further, users may be provided with information regarding what to do in the case of an accident.

### BRIEF DESCRIPTION OF THE FIGURES

FIG. 1 is a schematic flow chart diagram illustrating a method for collision reporting and repair from the perspective of a vehicle operator in accordance with the teachings of the present invention.

FIG. 2 is a schematic flow chart diagram illustrating a method for collision reporting and repair from the perspective of a repair entity.

FIG. 3 is a schematic diagram of an exemplary service network and data flow in accordance with the teachings of the present invention.

FIG. 3A is a schematic diagram depicting a first subset of the service network and data flow depicted in FIG. 3.

FIG. 3B is a schematic diagram depicting a second subset of the service network and data flow depicted in FIG. 3.

FIG. 3C is a schematic diagram depicting a third subset of the service network and data flow depicted in FIG. 3.

FIG. 3D is a schematic diagram depicting a fourth subset of the service network and data flow depicted in FIG. 3.

FIG. 4 depicts an exemplary user interface for a vehicle operator device in accordance with the teachings of the present invention.

FIG. 5 depicts an exemplary user interface for a repair entity device in accordance with the teachings of the present invention.

FIG. 6 is a schematic diagram depicting an exemplary electronic device suitable for use with the present inventions

### DETAILED DESCRIPTION OF THE INVENTION

The present invention is related to a system and method for the reporting and repair of damage to a vehicle. The system may involve a network, including (in some embodiments) a first user device such as a vehicle operator device, a server for providing a database of service providers, and a second user device such as a service provider device. The first user device may be, for example, a smart phone or vehicle-mounted information system. In some exemplary embodiments, the first user device includes a location determination unit, such as a GPS system, to determine the location of the first user device and, by extension, a vehicle involved in an accident. The location may be used to search for service providers that are located within a designated range of the vehicle or within a designated range of another location, such as the vehicle operator's home of place of business.

The system and method may provide a convenient and direct connection between vehicle operators and repair entities. In some exemplary embodiments a user is able to develop and maintain their own preferred group of repair entities. Still further, some embodiments of the present invention may search for, and allow a user to connect directly to, service companies like rental agencies.

Some exemplary embodiments described herein also facilitate the collection and reporting of information related to an accident. In some embodiments, emergency services or other services, such as rental companies, may be located and informed of the accident. Information may be collected and stored for use by repair entities or insurance companies. Further, users may be provided with information regarding what to do in the case of an accident.

Exemplary embodiments of the present invention are described below with reference to the attached drawings.

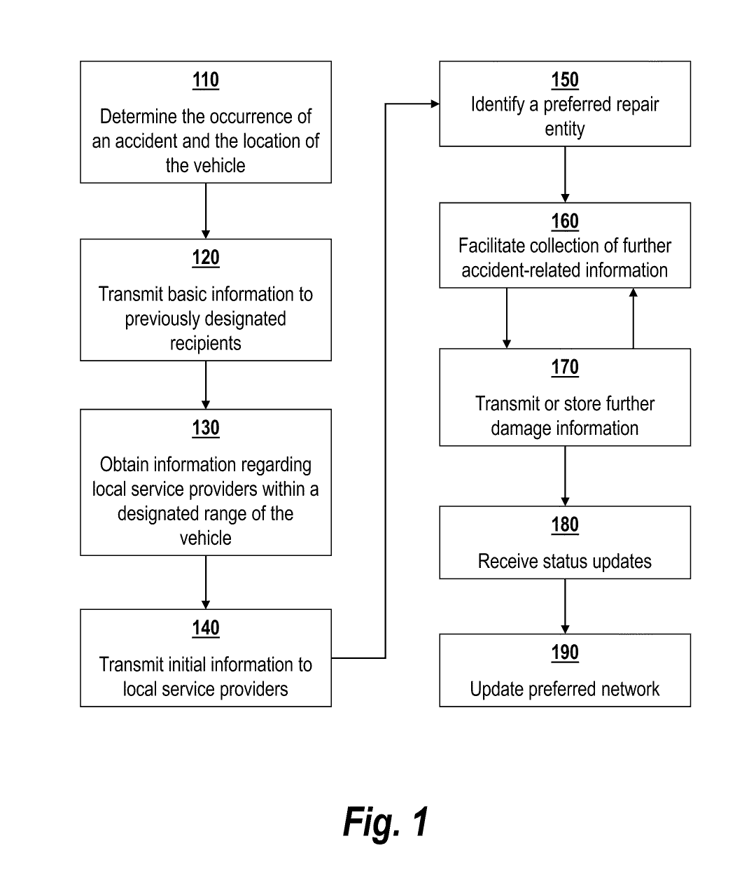

FIG. 1 is a schematic flow chart diagram illustrating a method for collision reporting and repair from the perspective of a vehicle operator in accordance with the teachings of the present invention. The flow chart diagram of FIG. 1 is an exemplary embodiment only. The elements depicted in FIG. 1 need not be performed in the specific order described, but may be performed in any order. Further, some elements may be omitted and some elements may be added without deviating from the scope of the invention. The elements depicted in FIG. 1 may be carried out as a method by an electronic device programmed with instructions to perform the method, as described in more detail below. The electronic device may be a vehicle operator device used by the operator of a vehicle involved in a collision.

At step 110, an occurrence of an accident related to a vehicle is determined. The occurrence of the accident may be determined based on user input. For example, a vehicle operator device providing a safety program in accordance with one embodiment of the present invention may provide a user interface including a button. When the user presses the button, or otherwise interacts with the safety program, the vehicle operator device determines that an accident has occurred. Alternatively, the occurrence of the accident may be detected using one or more sensors of the vehicle operator device. For example, the vehicle operator device may be an in-vehicle safety system that includes a sensor that detects when an airbag deploys. In this case, the vehicle operator device may determine the occurrence of an accident when the sensor detects the deployment of the airbag. In some embodiments, the vehicle operator device may ask for confirmation that an accident has occurred. A request for confirmation may be accompanied by one or more visual or audible alarms to attract a user's attention. The vehicle operator device may determine that an accident has occurred if the user confirms the accident, or alternatively, if no response is received from a user after a designated period of time. In other embodiments, the vehicle operator device may not ask for confirmation, but rather assume that an accident has occurred when certain conditions are met (such as the deployment of the vehicle's airbag, a sudden stop, a sudden deceleration, sudden rotation, the detection of an impact, a pressure or temperature change, or the like).

Further, the location of the vehicle or the vehicle operator device may be determined at step 110. The location of the vehicle or vehicle operator device may be determined using any suitable means, including (but not limited to) the use of a global positioning system or location triangulation based on multiple points, such as cell phone towers or radio towers. As used herein, the word “triangulation” means the determination of a location based on an object of interests' distance from more than one point, but not necessarily three points.

At step 120, basic information is transmitted to designated recipients. The basic information may include, for example, user information such as a name, address, and/or telephone number, last-known location information or calculated location information, information identifying other recipients of the basic information, and basic information collected by sensors on the electronic device, such as the deployment of airbags or the detection of an impact.

The basic information may be transmitted using a network, such as the Internet or a telecommunication network. If the information cannot be transmitted immediately, for example because of poor network coverage or conditions, the information may be stored in the memory of the vehicle operator device for future transmission. The vehicle operator device may make repeated attempts to transmit the information at regular intervals until the transmission is successful.

The recipients may be previously designated, for example by a user, or may be default recipients. The recipients may include, for example, a preferred repair shop designated by the user or otherwise programmed into the electronic device. The recipients may further include one or more recipients designated by a user, such as a relative, friend, spouse, family member, attorney, or other recipient. The recipients may be identified by a telephone number, an email address, a user name suitable for messaging, an address, or any other suitable identifying feature.

At step 130, the vehicle operator device may obtain information regarding service providers. The service providers may include repair entities, rental agencies, emergency services such as police stations, fire departments, hospitals, and other emergency responders, nearby branches of an insurance company, or the location of nearby vehicles that are obtainable by a vehicle sharing program, such as ZipCar.

The information may include an address, contact information such as a telephone number or email address, areas of expertise (such as brake repair for a repair entity, or the presence of a helicopter airlift unit at a hospital), and customer reviews of the service provider. The information may be obtained directly from the service provider, or alternatively provided through a dedicated database that collects, aggregates, and processes service provider information. The database may be provided by, for example, a server connected to the Internet.

If the vehicle operator device includes a location determination unit, the service providers may be selected based on their proximity to the determined location of the electronic deice. The service providers that are determined to be within a designated range of the vehicle operator device may be selected so that information about the nearby service providers may be obtained. The location of the service providers may be determined, for example, by an address or other street location. The distance to the service provider may be determined using a simple range calculation that ignores terrain and roads (e.g., an “as the crow flies” distance), or may be calculated based on the travel distance or time required to reach the service provider from the location of the vehicle operator device. An external mapping application, such as Google Maps or MapQuest, may be used to determine the distance to the service provider.

The service providers that are selected by the vehicle operator device may be selected based on proximity, as described above, relevance, expertise, reviews stored in the database, or may be selected due to their inclusion in a preferred list of services providers. A combination of approaches may also be used.

At step 140, initial information is transmitted from the vehicle operator device to the local service providers. The initial information may include any information accessible to the electronic device at the time that step 140 is carried out, such as a user name, contact information, location information, vehicle make, model, and year, and the fact that the vehicle has been involved in an accident. If the vehicle operator device includes seatbelt sensors or in-seat weight sensors, the electronic device may be able to determine the number of passengers in the vehicle and transmit this information along with the other basic information. The information may also be transmitted to the user's insurance company.

Alternatively, the information may be forwarded to the repair entity. The repair entity may generate a report, including accident information, a quote, or information related to the repair (such as information indicating the progress of the repair or current cost of the repair), and forward the report to the insurance company.

The vehicle operator device may include one or more sensors for determining the movement, status, or condition of the vehicle. For example, the sensors may detect the speed, direction, or orientation of the vehicle, the deployment status of airbags, and force sensors for detecting impacts at different points of the vehicle. The vehicle operator device may store information from the sensors to a storage of the vehicle operator device at regular intervals. In order to save storage space, the information may be compressed and/or overwritten at regular intervals, for example by employing a circular buffer. When an accident is detected at step 110, the vehicle operator device may stop overwriting the information in the storage. In this way, a record of events leading up to the accident may be preserved, for example for insurance claim purposes. This may allow the vehicle operator device to serve as a “black box” for the vehicle and preserve accident-related information. Such accident-related information may be transmitted at step 140 along with other initial information.

At step 150, a preferred repair entity may be identified. The preferred repair entity may be a default entity previously selected by a user, or may be selected from a list of local repair entities discovered at step 130. The vehicle operator device may present such a list to a user in a graphical user interface, and the user may select the preferred repair entity from the list.

At step 160, the vehicle operator device may facilitate the collection of further information related to the accident. For example, the vehicle operator device may allow a user to take photographs or videos of the accident. The vehicle operator device may further include a guide, wizard, or form that allows users to enter basic information, such as insurance information collected from other drivers involved in the accident. If location information could not be determined by the vehicle operator device, the location information may be provided at step 160 by the user. The user may also provide information related to the passengers in each vehicle, injuries suffered, and/or freeform notes regarding the accident.

At step 170, the vehicle operator device may transmit or store the further information related to the accident. The vehicle operator device may store the information locally on a storage associated with the vehicle operator device, or may store the information remotely, for example on a server. The vehicle operator device may transmit the further information to designated service providers, such as the preferred repair entity or local hospitals or police departments.

If one of the recipients of the transmitted information determines that more information is necessary, steps 160 and 170 may be repeated. For example, upon receiving pictures of a vehicle involved in the accident, the preferred repair entity may wish to quote the user a price for performing a repair of the vehicle. The preferred repair entity may determine that more information is necessary before performing the quote, such as a video of the vehicle or a picture of the vehicle from another angle. Accordingly, the preferred repair entity may request such information, and the vehicle operator device may facilitate the collection of the requested information and transmit the requested information to the preferred repair entity.

Information collected, transmitted, and stored at steps 160 and 170 may also be provided to the vehicle owner or operator's insurance company.

At step 180, after the vehicle owner/operator has submitted the vehicle for repair, the vehicle operator device may receive status updates, such as updates on the status of repairs from the preferred repair entity. In this way, the preferred repair entity may request authorization to perform additional work, inform a vehicle owner/operator that repairs are finished, etc.

At step 190, a preferred network of service providers may be updated. The vehicle operator device may maintain a preferred network of service providers, of the preferred network may be maintained remotely, such as on a server connected to the internet. The preferred network may represent service providers that the vehicle owner or operator has used and with whom the vehicle owner or operator has had a positive experience, or may represent recommended service providers based on reviews, default settings, or a list of recommended service providers maintained by a third party. If the vehicle owner/operator had a positive experience with a preferred repair entity, for example, the user may update their preferred network of service providers to include the preferred repair entity. Alternatively, if the vehicle owner or operator has a bad experience with a service provider in the preferred network of service providers, the user may remove the service provider from the network. The preferred network of service providers may be used to provide designated recipients at step 120, may be used to provide a local service provider at step 130, and may be used to influence the order of search results for local service providers.

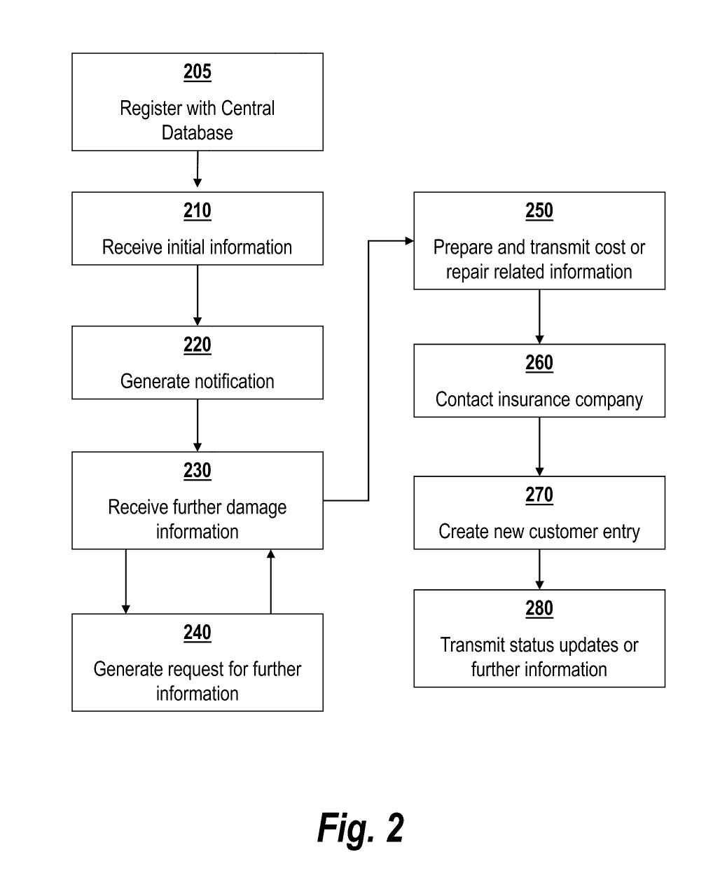

FIG. 2 is a schematic flow chart diagram illustrating a method for collision reporting and repair from the perspective of a repair entity. The flow chart diagram of FIG. 2 is an exemplary embodiment only. The elements depicted in FIG. 2 need not be performed in the specific order described, but may be performed in any order. Further, some elements may be omitted and some elements may be added without deviating from the scope of the invention. The elements depicted in FIG. 2 may be performed as a method in an electronic device programmed to perform the method. For example, the method may be performed by a service provider device for use by a service provider.

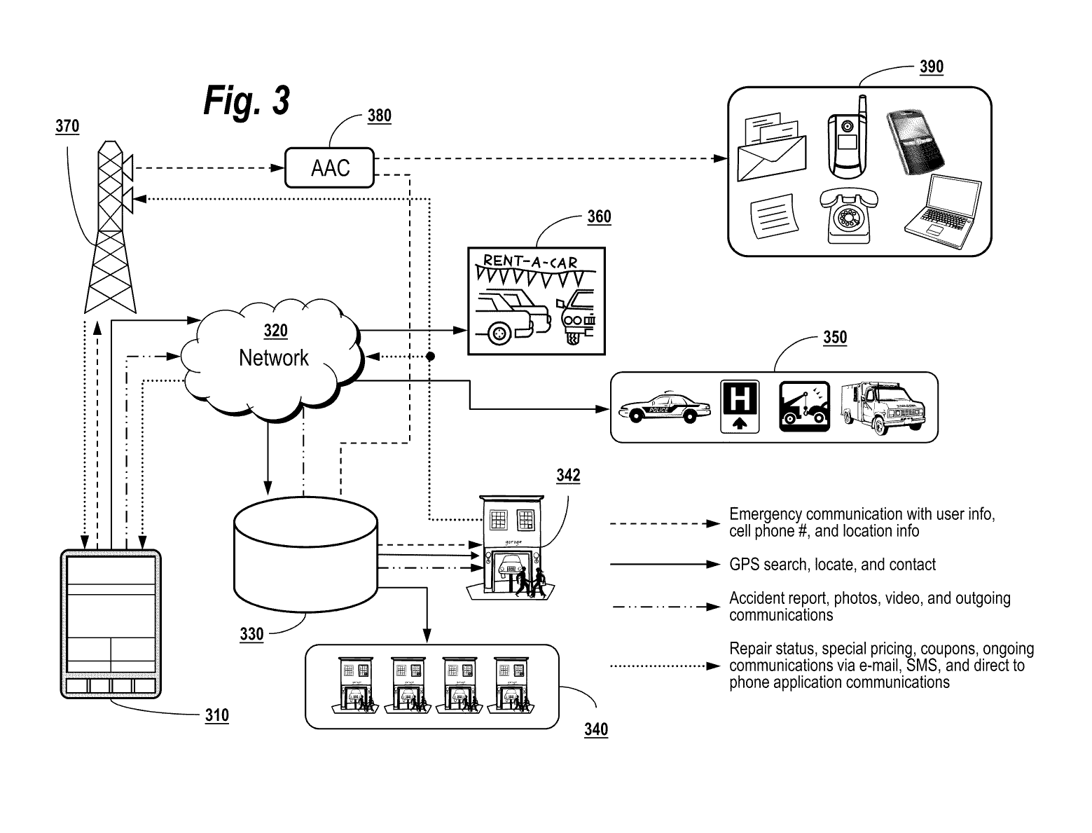

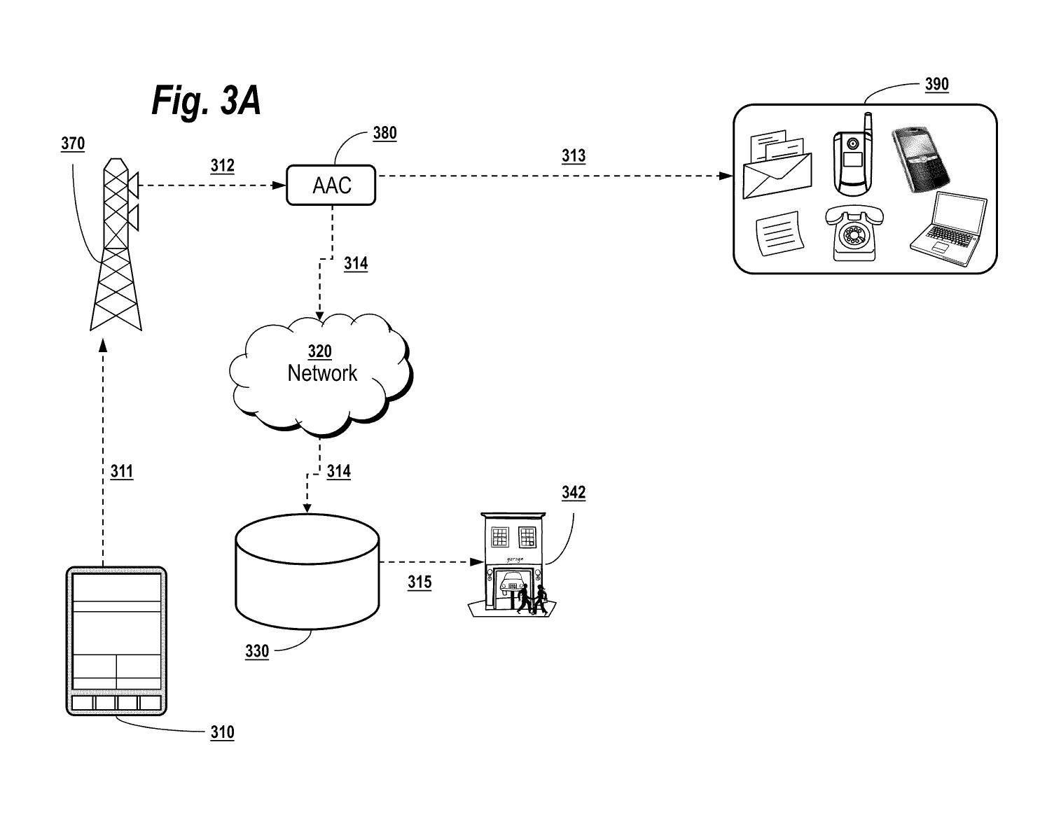

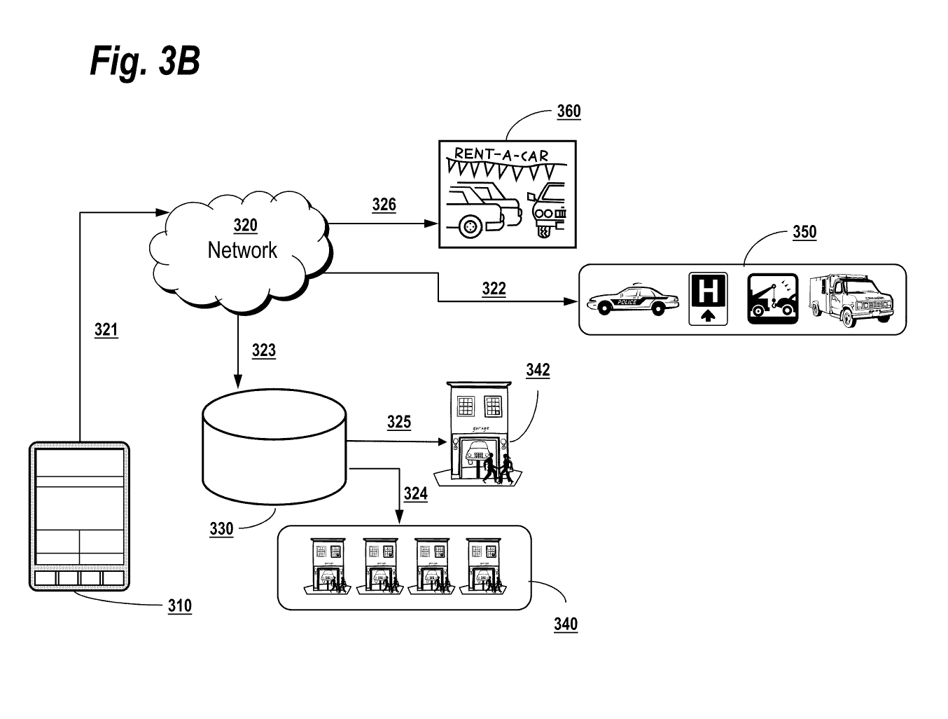

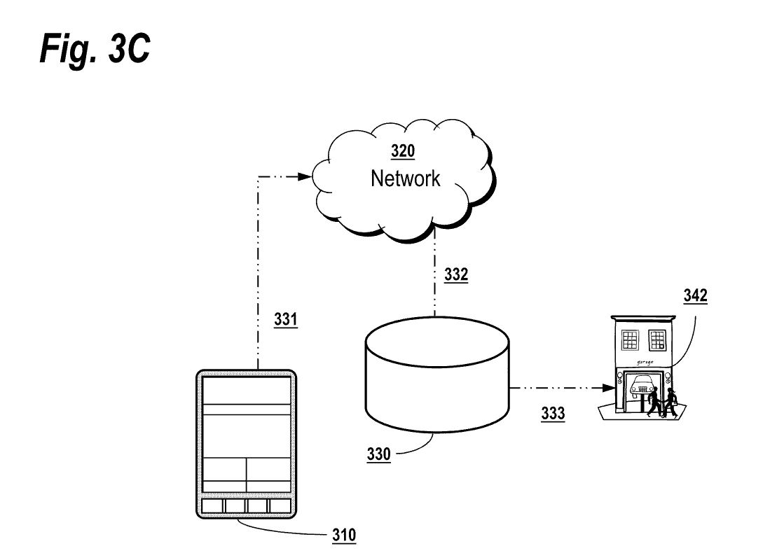

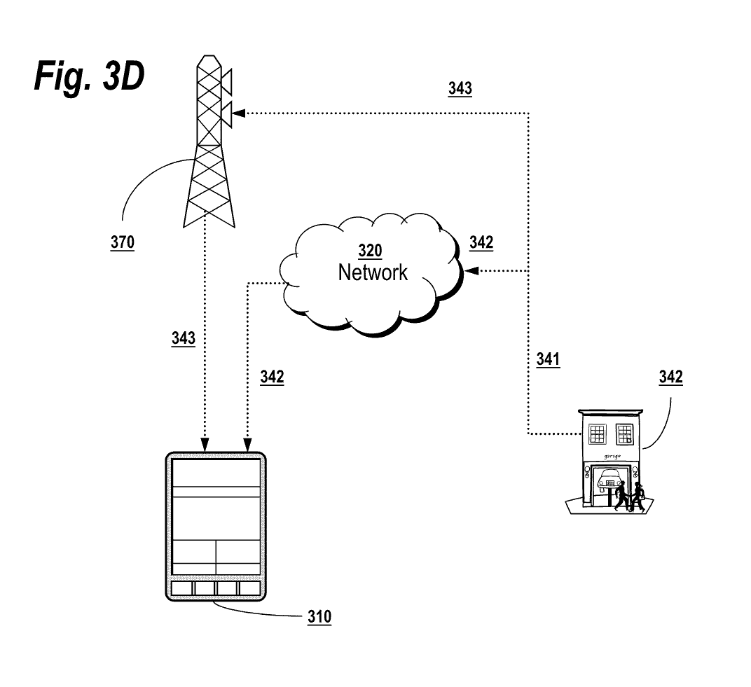

At step 205, the service provider may register with a central database, such as the database 330 (described in more detail with respect to FIG. 3 below). The database may provide information about local service providers to a vehicle operator in step 130, above. The service provider may provide, for example, location information, a list of services provided, or quotes for services.

At step 210, the service provider device may receive basic information about an accident. The basic information may include, for example, the information collected and transmitted at steps 110 and 120 above. The basic information may provide an initial identification that an accident has occurred in the local area, and that further information may be forthcoming.

At step 220, the service provider device may generate a notification. The notification may inform the repair entity that an accident has occurred nearby, and that there may be an opportunity to perform repairs. The notification may include a visible or audible alarm to draw the attention of the repair entity. The repair entity may review the notification, and either decide to ignore, delete, respond to the notification, or store the information in the notification using the service provider device for later use. In one embodiment, the repair entity may provide an indication that the repair entity wishes to perform the repair; for example, the repair entity may transmit a quote for performing the repair or otherwise indicate to the vehicle operator that the repair entity is willing to perform the repair.

At step 230, further information may be received by the service provider device. The further information may be, for example, information collected and transmitted at steps 160 and 170, described above. The further information may be presented to the repair entity in a user interface, such as a graphical user interface. The further information may also include a request by a vehicle operator or owner to have necessary repairs performed by the repair entity, or a request for a quote to repair the vehicle.

The repair entity may determine that still further information is required before committing to perform repairs to the vehicle, or before quoting a price for repairs. Accordingly, at step 240, the electronic device may generate a request for further information from the vehicle owner or operator. The request may be a default request based on preset settings or preferences from the repair entity, or may be a custom request. Steps 230 and 240 may be repeated as necessary.

At step 250, the electronic device may prepare and transmit a price quote or other repair related information. The price quote and other information may be automatically generated by the electronic device based on predetermined information or based on an automated analysis of the information received at steps 210 and 230. Alternatively, the price quote and other information may be entered by the repair entity.

At step 260, the electronic device may contact the insurance company that issued the vehicle owner or operator's insurance policy. The insurance company may be identified, for example, in step 210 or step 230. At step 260, the insurance company and the repair entity may establish an agreed price for performing the repairs, and may make any other suitable arrangements.

At step 270, the service provider device may create a new customer entry in a database. The new customer entry may include details related to the repair or the customer. The customer entry may be automatically populated with information received at steps 210 and 230, and information obtained at steps 250 and 260. The customer entry created at step 270 may be referenced during the course of repairs, or may be used later to transmit a bill or offers to the customer, or otherwise maintain customer relationships.

At step 280, status updates or further information may be transmitted to the customer. The status updates may be the status updates described above with respect to step 180. The status updates may be automatically generated by the service provider device, or alternatively may be entered by the repair entity. Other information, such as advertisements or special offers, may alternatively be provided to the customer at step 280.

FIG. 3 is a schematic diagram of an exemplary service network and data flow in accordance with the teachings of the present invention. The schematic diagram of FIG. 3 is an exemplary embodiment only. Some elements depicted in FIG. 3 may be omitted and some elements may be added without deviating from the scope of the invention.

Electronic device 310 is an electronic device for use by a vehicle operator or owner, and may include (for example) a mobile phone or in-vehicle information system. The electronic device 310 may perform the steps described above with reference to FIG. 1.

The electronic device 310 may include a transmitter and receiver for communicating with a network 320, such as the Internet, a Metropolitan Area Network (MAN), Wide Area Network (WAN), Local Area Network (LAN), or other suitable network. The network 320 may be interfaced with a database 330, which may be provided as a part of the network or provided separately from the network and connected through a separate interface. The database 330 may maintain lists of service providers 340, 342, 350, 360 and/or user electronic devices, such as electronic device 310.

Repair entities 340 may be connected to the network through database 330. Alternatively, the repair entities 340 may be connected directly to the network 320. The repair entities 340 include entities that are capable of performing repairs on a vehicle, including body shops and garages. One or more repair entities 340 in the database 330 may be a preferred repair entity 342. A preferred repair entity 342 is a repair entity that has been designated as preferred, either by inclusion in a user's network of preferred service providers, or by being designated as a preferred repair entity 342 by a third party.

Emergency services 350 include emergency responders that may be called to the scene of an accident. Some examples of emergency services 350 include police departments, fire departments, hospitals, ambulance services, tow-truck operators.

Service providers 360 include non-emergency providers of services that are related to vehicle collisions. Examples of service providers 360 include rental car agencies, insurance companies, car sharing programs, and taxi services.

In addition to the network 320, the electronic device 310 may communicate through a dedicated communication network 370. Examples of dedicated communication networks 370 include telecommunications networks and satellite based communications networks. The telecommunication network may allow for communication using, for example, telephonic means, radio waves, optics, and other suitable means, in a variety or format, such as email, voice, Voice over Internet Protocol (VoIP), simple messaging system (SMS), multimedia messaging system (MMS), and other suitable formats.

The electronic device 310 may generate an automatic accident communication 380 and send the automatic accident communication 380 through the dedicated communication network 370 to one or more designated recipients 390. The designated recipients may include relatives, friends, a spouse, neighbors, coworkers, an attorney, or others designated by a user of the electronic device 310.

The data flow depicted in FIG. 3 is shown in more detail with respect to FIGS. 3A-3D. In FIGS. 3 and 3A-3D, like elements are designated with the same reference numerals.

FIG. 3A is a schematic diagram depicting a first subset of the service network and data flow depicted in FIG. 3. FIG. 3A generally corresponds to the data flow as described in step 120 of FIG. 1. Having determined the occurrence of an accident, the electronic device 310 may transmit 311 initial accident-related information towards designated recipients 390 and previously a designated preferred repair entity 342. The transmission 311 including the automatic accident communication 380 is routed through the dedicated communication network 370, which further routes 312 the automatic accident communication 380 towards one or more destinations. The automatic accident communication 380 is transmitted 313 directly to designated recipients 390, and is also transmitted 314 to the database 330. The database 330 may be searched for preferred repair entities 342, and the automatic accident communication 380 may be transmitted 315 to any discovered preferred repair entities 342.

Alternatively, if the electronic device maintains a local copy of preferred repair entities 342, the automatic accident communication 380 may be routed directly to one or more preferred repair entities 342 in the manner of transmission 313, without being routed through the database 330.

FIG. 3B is a schematic diagram depicting a second subset of the service network and data flow depicted in FIG. 3. FIG. 3B generally corresponds to the data flow as described above with reference to steps 130 and 140 of FIG. 1.

The electronic device 310 generates a request for information, possibly including the current location of the electronic device 310, and transmits 321 the request to the network 320. The network 320 may be searched for emergency services 350 and non-emergency service providers 360. As a result, the electronic device 310, through the network 320, may contact emergency services 350 and transmit 322 basic information to the emergency service providers 350. In addition, the electronic device 310, through the network 320, may contact non-emergency service providers 360 and transmit 326 the basic information to the non-emergency service providers 360.

The electronic device 310 may also, through the network 320, transmit 323 the basic information to the database 330, which may be searched for nearby repair entities 340. The basic information is provided 324 to the nearby repair entities 340. In addition, because the basic information may include more detail than the initial transmission provided early to the preferred repair entities 342, the preferred repair entities 342 are provided 325 with the basic information.

FIG. 3C is a schematic diagram depicting a third subset of the service network and data flow depicted in FIG. 3. FIG. 3C generally corresponds to the data flow as described above with reference to step 170 of FIG. 1.

The electronic device 310 may transmit 331 further accident related information through the network 320, as described in more detail above. The network may route 332 the further information through the database 330, and the database 330 may route 333 the to a preferred service provider 342. If more information is requested at step 240 (see FIG. 2), the data flow of FIG. 3C may be reversed and repeated as necessary.

FIG. 3D is a schematic diagram depicting a fourth subset of the service network and data flow depicted in FIG. 3. FIG. 3D generally corresponds to the data flow as described above with reference to step 180 of FIG. 1. Having prepared a status update, the preferred repair entity may transmit 341 the status update. The transmission may be routed 342 through the network 320, or may be routed 343 through the dedicated communications network, or both.

FIGS. 3 and 3A-3D depict two networks, a network 320 and a dedicated communication network 370. However, the steps described above may also be implemented in a single network, or in more than two networks. In the case that more than one network is provided but one of the networks is inaccessible, the remaining accessible network may be used to route information designated in the above figures for the inaccessible network.

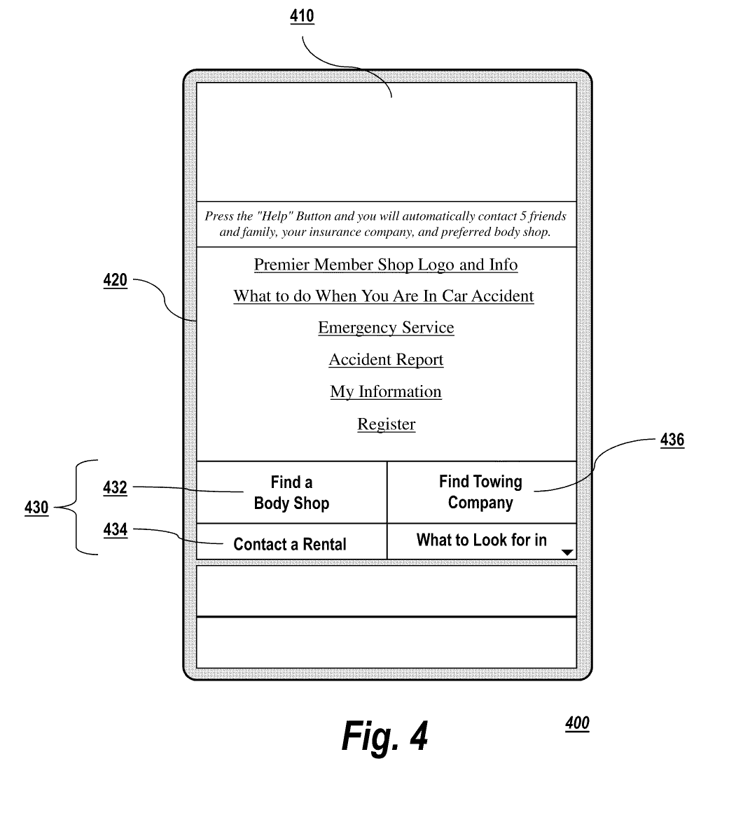

FIG. 4 depicts an exemplary user interface 400 for a vehicle operator device in accordance with the teachings of the present invention. The user interface 400 includes a help button 410. When a user presses the help button 410, the vehicle operator device determines that an accident has occurred and transmits initial information regarding the accident to designated recipients.

The user interface 400 further includes a main window 420. The main window 420 provides a number of options related to the software program and presents useful information to a user, such as what a vehicle operator should do in the case of an accident.

Action buttons 430 present further options that allow a user to interact with the system. When an option is selected by pressing one of the action buttons 430, further information may be displayed in the main window 420. For example, if a user selects the “Find a Body Shop” button 432. a list of nearby body shops may appear in the main window 420. If the user selects the “Contact a Rental Company” button 434, or the “Find a Towing Company” button 436, a list of nearby service providers may be presented in the main window 420.

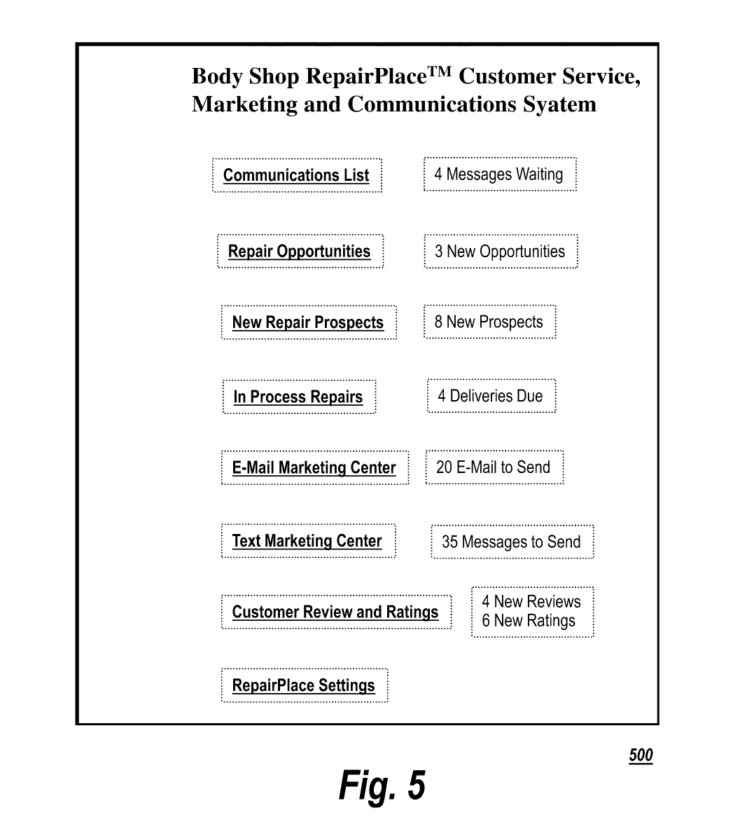

FIG. 5 depicts an exemplary user interface 500 for a service provider device for use by a repair entity in accordance with the teachings of the present invention. The left side of the user interface 500 presents buttons describing different functionalities and options, such as incoming communications, repairs already in progress, customer reviews, and new opportunities for performing repairs. The right hand side presents status updates for each of the corresponding functionalities options on the left hand side. A user may select either the button on the left hand side of the user interface 500 or the button on the right hand side of the user interface 500 to obtain more information related to the functionalities, options, and statuses presented in the user interface.

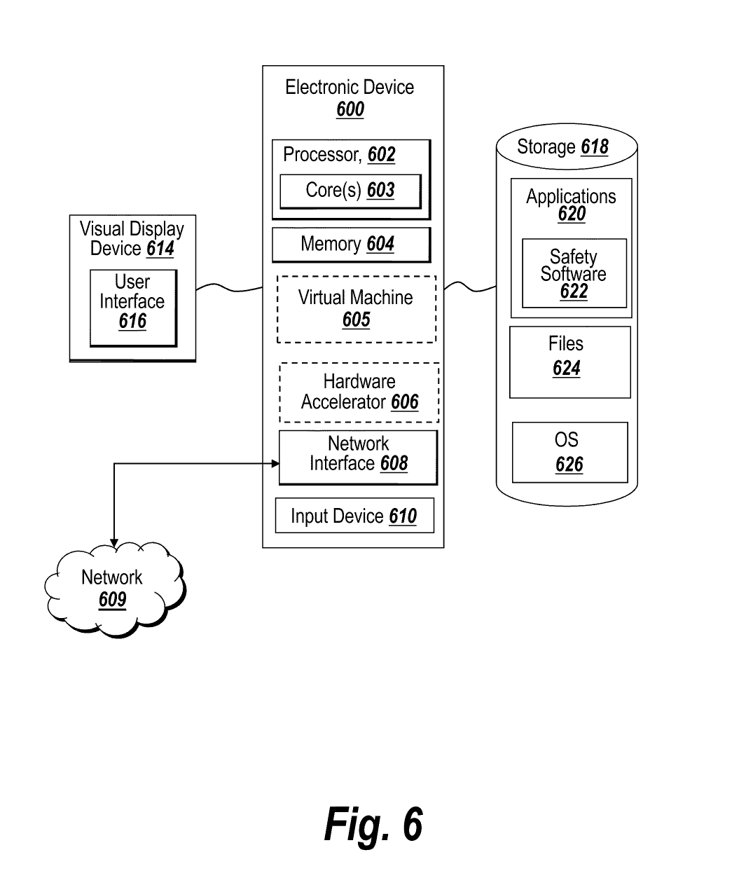

FIG. 6 depicts an exemplary electronic device 600 suitable for practicing exemplary embodiments described herein. The electronic device 600 may take many forms, including but not limited to a mobile telecommunications system, a vehicle mounted information system, a computer, workstation, server, network computer, quantum computer, optical computer, Internet appliance, mobile device, a pager, a tablet computer, a smart sensor, application specific processing device, etc.

In some exemplary embodiments described herein, the electronic device 600 is a mobile telecommunications system. Examples of mobile telecommunications system include, but are not limited to mobile phones, including smart phones, such as an iPhone from Apple Computer, Inc., a Blackberry from Research in Motion, Ltd., a Treo or Pre from Palm, Inc., an E71 from Nokia, a G1 from HTC Corp., or a custom designed mobile phone.

In some exemplary embodiments described herein, the electronic device 600 may be a vehicle-mounted information system. Examples of vehicle-mounted information systems include, but are not limited to, in-vehicle entertainment systems, GPS devices, traffic information systems, a vehicle diagnostic systems, an OnStar system from General Motors, and other vehicle-based safety or information systems.

The implementation of FIG. 6 is illustrative and may take other forms. For example, an alternative implementation of the computing device 600 may have fewer components, more components, or components that are in a configuration that differs from the configuration of FIG. 6. The components of FIG. 6 and/or other figures described herein may be implemented in hardware based logic, software based logic and/or logic that is a combination of hardware and software based logic (e.g., hybrid logic); therefore, the components of FIG. 6 and/or other figures are not limited to a specific type of logic.

The processor 602 may include hardware or software based logic to execute instructions on behalf of the electronic device 600. In one implementation, the processor 602 may include one or more processors, such as a microprocessor. In one implementation, the processor 602 may include hardware, such as a digital signal processor (DSP), a field programmable gate array (FPGA), a Graphics Processing Unit (GPU), an application specific integrated circuit (ASIC), a general-purpose processor (GPP), etc., on which at least a part of applications can be executed. In another implementation, the processor 602 may include single or multiple cores 603 for executing software stored in a memory 604, or other programs for controlling the electronic device 600.

The electronic device 600 may include one or more tangible electronic device readable storage media for storing one or more electronic device executable instructions or software for implementing exemplary embodiments. For example, a memory 604 included in association with the electronic device 600 may store electronic device executable instructions or software, e.g. instructions for implementing and processing every module of a programming environment. The memory 604 may include a computer system memory or random access memory (RAM), such as dynamic RAM (DRAM), static RAM (SRAM), extended data out RAM (EDO RAM), etc. The memory 604 may include other types of memory as well, or combinations thereof. In some electronic devices, memory 604 may be allocated dynamically, while in other electronic devices, memory 604 may be allocated statically.

In one implementation, one or more processors 602 may include a virtual machine (VM) 605 for executing the instructions loaded in the memory 604. A virtual machine 605 can be provided to handle a process running on multiple processors so that the process appears to be using only one computing resource rather than multiple. Virtualization can be employed in the electronic device 600 so that infrastructure and resources in the electronic device can be shared dynamically. Multiple VMs 605 may be resident on a single processor 602.

A hardware accelerator 606, such as implemented in an ASIC, FPGA, or the like, can additionally be used to speed up the general processing rate of the electronic device 600.

Additionally, the electronic device 600 may include a network interface 1108, which may include a transmitter and/or a receiver, to interface to a Local Area Network (LAN), Wide Area Network (WAN) or the Internet through a variety of connections including, but not limited to, standard telephone lines, LAN or WAN links (e.g., T1, T3, 56kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. Network interface 608 may include a built-in network adapter, network interface card, personal computer memory card international association (PCMCIA) network card, card bus network adapter, wireless network adapter, universal serial bus (USB) network adapter, modem or any other device suitable for interfacing the electronic device 600 to any type of network capable of communication and performing the operations described herein, such as the Internet.

The electronic device 600 may include one or more input/output (I/O) devices 610 such a keyboard, a touch screen, a multi-point touch interface, a voice recognition device, or a pointing device, for example a mouse, for receiving input from a user.

The one or more input/output devices 610 may further include one or more sensors for detecting the occurrence of an accident. The sensors may include an accelerometer, an altimeter, a pressure sensor, a temperature sensor, a diagnostic sensor for detecting a state of the vehicle, such as a state of the vehicle's engine or the deployment of an airbag, a force sensor, a gyroscope, a direction sensor such as a compass, or an impact sensor.

The one or more input/output devices 610 may further include one or more sensors for collecting information about the vehicle and its occupants. For example, the sensors may include seatbelt sensors or in-seat weight sensors for determining the number of riders in a vehicle.

The input/output devices 610 may further include a location determination unit for determining the location, speed, and/or direction of the vehicle. Examples of location determination units include, but are not limited to, a global positioning system or a triangulation system, such as a system that triangulates a location using cell phone towers. The electronic device 600 may include other suitable I/O peripherals.

The input devices 610 may be connected to a visual display device 614. A graphical user interface (GUI) 616 may be shown on the display device 614. A user may interact with the GUI 616 using one or more of the input/output devices 610.

A storage device 618 may also be associated with the electronic device 600. The storage device 618 may be, for example, a hard-drive, CD-ROM or DVD, Zip Drive, tape drive, or other suitable tangible electronic device readable storage medium capable of storing information. The storage device 618 may be useful for storing application software programs, such as safety software 622 for reporting a collision and facilitating the repair of a vehicle, and an operating system (OS).

The electronic device 600 can be running any operating system 626 such as any of the versions of the Microsoft® Windows® operating systems, the different releases of the Unix and Linux operating systems, any version of the MacOS® for Macintosh computers, the Google Android operating system, any embedded operating system, any real-time operating system, any open source operating system, any proprietary operating system, any operating systems for mobile computing devices, or any other operating system capable of running on the computing device and performing the operations described herein. The operating system may be running in native mode or emulated mode.

Exemplary embodiments may be provided as one or more computer-readable programs embodied on or in one or more mediums, such as a tangible, computer-readable storage medium. The mediums may be, but are not limited, to a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), or a magnetic tape.

The computer-readable programs may be implemented in any suitable programming language. Some examples of suitable languages include Python, C, C++, C#, Java, Javascript, a hardware description language (HDL), UML, PLC, etc. Further, the computer readable programs may be implemented in a hardware description language or any other language that allows prescribing computation. The software programs may be stored on or in one or more mediums as object code. Instructions in the programming languages may be executed by one or more processors to implement the computer readable programs described in the programming languages, or alternatively the instructions may be implemented directly by hardware components other than a processor.

The foregoing description of exemplary embodiments provides illustration and description, but is not intended to be exhaustive or to limit the invention to the precise form disclosed. Modifications and variations are possible in light of the above teachings or may be acquired from practice of the invention. For example, while a series of acts has been described above, the order of the acts may be modified in other implementations consistent with the principles of the invention. Further, non-dependent acts may be performed in parallel.

In addition, implementations consistent with principles of the invention can be implemented using devices and configurations other than those illustrated in the Figures and described in the Specification without departing from the spirit of the invention. Devices and/or components may be added and/or removed from the implementations of the figures depending on specific deployments and/or applications. Also, disclosed implementations may not be limited to any specific combination of hardware.

Furthermore, certain portions of the invention may be implemented as logic that performs one or more functions. This logic may include hardware, such as hardwired logic, an application-specific integrated circuit, a field programmable gate array, a microprocessor, software, wetware, or a combination of hardware and software. Certain portions of the invention may also be implemented in a distributed or parallel manner, and may run on one or more electronic devices. The components described may be integrated into a single device, or distributed among several devices.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise.

The scope of the invention is defined by the claims and their equivalents.

1. A method, performed in an electronic device, for facilitating the repair of a vehicle by a repair entity, the method comprising:
registering an electronic device associated with a repair entity with a central database;
receiving, at the electronic device associated with a repair entity, information related to an accident involving the vehicle, the information provided by an electronic device associated with the vehicle or an operator of the vehicle on the basis of the registration in the central database; and
transmitting information related to the repair to the electronic device associated with the vehicle or operator.

2. The method of claim 1, further comprising generating a notification in response to the receipt of the information indicating the occurrence of the accident.

3. The method of claim 1, further comprising:
generating, at the electronic device associated with the repair entity, a request for further information; and
forwarding the request for further information from the electronic device associated with the repair entity to the electronic device associated with the vehicle or operator.

4. The method of claim 1, further comprising programmatically generating a new customer entry in a database of customer information at the repair entity, the new customer entry automatically populated with at least some of the received information.

5. The method of claim 1, further comprising receiving a location of the vehicle.

6. The method of claim 5, wherein the electronic device associated with the repair entity receives the information indicating the occurrence of the accident when the electronic device is within a designated range of the vehicle.

7. The method of claim 1, further comprising:
generating, at the electronic device associated with the repair entity, a report related to the repair; and
forwarding the report to an insurance company associated with the operator or the vehicle.

8. The method of claim 1, further comprising transmitting status updates related to a repair of the vehicle from the electronic device associated with the repair entity to the electronic device associated with the vehicle or operator.

9. The method of claim 1, wherein the electronic device receives the information indicating the occurrence of the accident from a third-party server that maintains a list of preferred repair entities, and further comprising updating the list of preferred repair entities with information related to the repair entity.

10. The method of claim 1, wherein information related to the accident is stored in a storage of the electronic device associated with the repair entity.

11. A system for facilitating a repair of a vehicle, the system comprising:
a storage for storing information related to the vehicle or the operator of the vehicle; and
a processor programmed with instructions, the instructions causing the processor to:
register the system with a central database,
receive information related to the accident from an electronic device associated with the vehicle or an operator of the vehicle on the basis of the registration in the central database,
display the information related to the accident to a user, and
transmit information related to the repair to the electronic device associated with the vehicle or operator.

12. The system of claim 11, wherein the processor is further programmed to generate a notification in response to the receipt of the information indicating the occurrence of the accident.

13. The system of claim 11, wherein the processor is further programmed to:
generate, at the electronic device associated with the repair entity, a request for further information; and
forward the request for further information from the electronic device associated with the repair entity to the electronic device associated with the vehicle or operator.

14. The system of claim 11, wherein the processor is further programmed to generate a new customer entry in a database of customer information at the repair entity, the new customer entry automatically populated with at least some of the received information.

15. The system of claim 11, wherein the processor is further programmed to receive a location of the vehicle.

16. The system of claim 15, wherein the processor receives the information indicating the occurrence of the accident when the system is within a designated range of the vehicle.

17. The system of claim 11, wherein the processor is further programmed to:
generate, at the electronic device associated with the repair entity, a report related to the repair; and
forward the report to an insurance company associated with the operator or the vehicle.

18. The system of claim 11, wherein the processor is further programmed to transmit status updates related to a repair of the vehicle from the electronic device associated with the repair entity to the electronic device associated with the vehicle or operator.

19. The system of claim 11, wherein the processor is further programmed to receive the information indicating the occurrence of the accident from a third-party server that maintains a list of preferred repair entities, and update the list of preferred repair entities with information related to the repair entity.

20. The system of claim 11, wherein information related to the accident is stored in the storage.

21. A non-transitory electronic device readable medium comprising instructions that, when executed by an electronic device associated with a repair entity, cause the electronic device to:
register an electronic device with a central database;
receive, at the electronic device, information related to an accident involving a vehicle, the information provided by an electronic device associated with the vehicle or an operator of the vehicle on the basis of the registration in the central database; and
transmit information related to the repair to the electronic device associated with the vehicle or operator.

22. The medium of claim 21, further comprising instructions for generating a notification in response to the receipt of the information indicating the occurrence of the accident.

23. The medium of claim 21, further comprising instructions for:
generating, at the electronic device associated with the repair entity, a request for further information; and
forwarding the request for further information from the electronic device associated with the repair entity to the electronic device associated with the vehicle or operator.

24. The medium of claim 21, further comprising instructions for programmatically generating a new customer entry in a database of customer information at the repair entity, the new customer entry automatically populated with at least some of the received information.

25. The medium of claim 21, further comprising instructions for receiving a location of the vehicle.

26. The medium of claim 21, further comprising instructions for:
generating, at the electronic device associated with the repair entity, a report related to the repair; and
forwarding the report to an insurance company associated with the operator or the vehicle.

27. The medium of claim 21, further comprising instructions for transmitting status updates related to a repair of the vehicle from the electronic device associated with the repair entity to the electronic device associated with the vehicle or operator.
